(19) United States
(12) Patent Application Publication
(10) Pub. No.: US 2022/0185273 A1
(43) Pub. Date: Jun. 16, 2022

(54) VEHICLE ASSIST SYSTEM

(71) Applicant: ZF FRIEDRICHSHAFEN AG, Friedrichshafen (DE)

(72) Inventors: DANIEL E. WILLIAMS, Thorntown, IN (US); WILLIAM F SANCHEZ COSSIO, West Lafayette, IN (US)

(21) Appl. No.: 17/123,192

(22) Filed: Dec. 16, 2020

(51) Int. Cl. B60W 30/12; B60W 40/08; B60W 40/06; B60W 50/16

(52) U.S. Cl. CPC B60W 30/12; B60W 40/08; B60W 40/06; B60W 2556/10; B60W 2552/53; B60W 2554/80; B60W 50/16

(57) ABSTRACT

A method for assisting the operation of a vehicle traveling on a roadway includes detecting at least one lane line on the roadway. A line of engagement is generated for each lane line and spaced from a centerline of each respective lane line. A distance between the vehicle and the positioned lines of engagement is monitored. Lane keep assistance is automatically performed in response to the vehicle position relative to the lines of engagement.

### TECHNICAL FIELD

The present invention relates generally to vehicle systems and, more specifically, relates to a vehicle assist system for helping to keep the vehicle within a roadway lane.

### BACKGROUND

Current driver assistance systems (ADAS—advanced driver assistance system) offer a series of monitoring functions in vehicles. In particular, the ADAS can monitor the environment around the vehicle and notify the driver of the vehicle of conditions therein. To this end, the ADAS can capture images of the surrounding environment and digitally process the images to extract information. The information is used for lane detection to help maintain the vehicle within the intended driving lane.

### SUMMARY

In one aspect of the present invention, a method for assisting the operation of a vehicle traveling on a roadway includes detecting at least one lane line on the roadway. A line of engagement is generated for each lane line and spaced from a centerline of each respective lane line. A distance between the vehicle and the positioned lines of engagement is monitored. Lane keep assistance is automatically performed in response to the vehicle position relative to the lines of engagement.

In another aspect, a method for assisting operation of a vehicle traveling on a roadway includes detecting lane lines on the roadway. Inner and outer lines of engagement for each lane line are generated and spaced a predetermined distance from one another. The inner and outer lines of engagement are spaced from a centerline of each respective lane line. Lane keep assistance is automatically performed in response to the vehicle crossing either of the inner lines of engagement.

Other objects and advantages and a fuller understanding of the invention will be had from the following detailed description and the accompanying drawings.

### BRIEF DESCRIPTION OF THE DRAWINGS

FIG. 1 is a top view of a vehicle having an assist system in accordance with an embodiment of the present invention.

FIG. 2 is a schematic illustration of the assist system of FIG. 1.

FIG. 3 is a schematic illustration of the vehicle traveling on a roadway and sensing objects around the vehicle with camera assemblies.

FIG. 4 is a schematic illustration of the roadway from the operator perspective and including lines of engagement.

FIG. 5A is a schematic illustration of the roadway of FIG. 4 with widened lines of engagement.

FIG. 5B is a schematic illustration of the roadway of FIG. 4 with narrowed lines of engagement.

FIG. 6A is a schematic illustration of the roadway of FIG. 4 with multiple pairs of widened lines of engagement.

FIG. 6B is a schematic illustration of the roadway of FIG. 4 with multiple pairs of narrowed lines of engagement.

### DETAILED DESCRIPTION

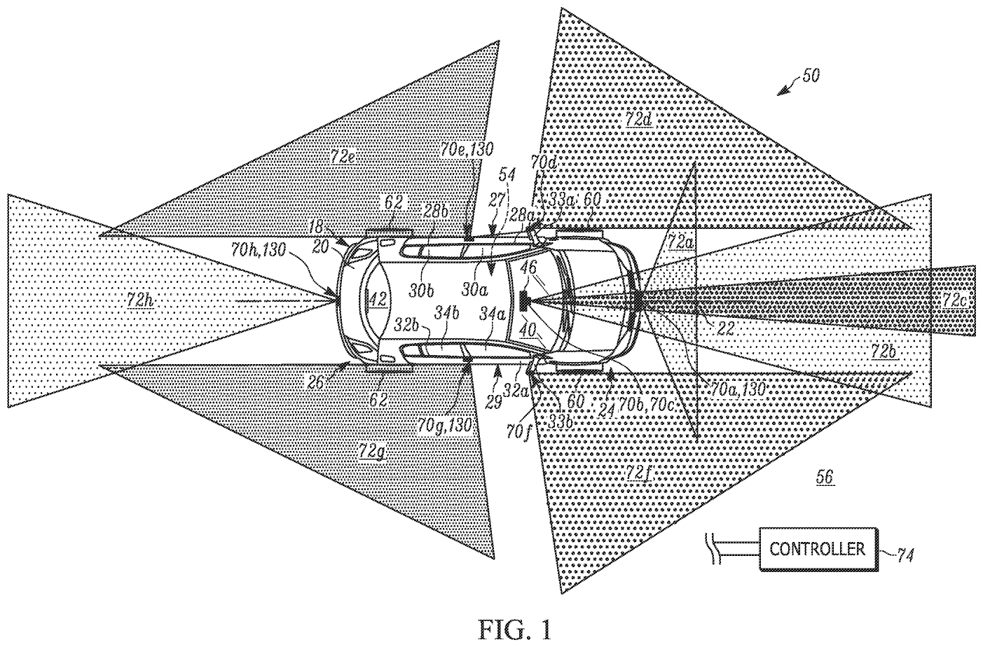

The present invention relates generally to vehicle systems and, more specifically, relates to a vehicle assist system for helping to keep the vehicle within a roadway lane. FIG. 1 illustrates a vehicle 20 having an example assist system 50 in accordance with the present invention. The vehicle 20 can a commercial vehicle, semi, emergency vehicle, passenger vehicle, bus, etc.

The vehicle 20 extends along a centerline 22 from a front end 24 to a rear end 26. The vehicle 20 includes a left side 27 and a right side 29 positioned on opposite sides of the centerline 22. The left side 27 includes a pair of doors 28a, 28b each having an associated window 30a, 30b. The right side 29 includes a pair of doors 32a, 32b each having an associated window 34a, 34b. A side view mirror 33a is connected to the door 28a. Another side view mirror 33b is connected to the door 32a.

The front end 24 of the vehicle 20 includes a front window or windshield 40 extending generally between the left and right sides 27, 29. A rear view mirror 46 is secured to the windshield 40. The rear end 26 of the vehicle 20 includes a rear window 42 extending generally between the left and right sides 27, 29. The windows 30a, 30b, 32a, 32b, 40, 42 and doors 28a, 28b, 32a, 32b collectively help define an interior 54 of the vehicle 20. The exterior of the vehicle 20 is indicated generally at 56.

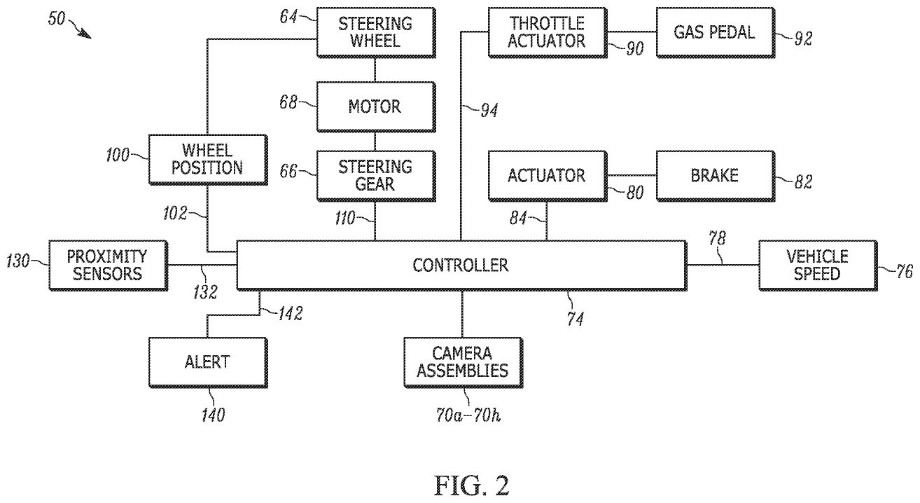

The vehicle 20 includes a pair of front steerable wheels 60 and a pair of rear wheels 62. The front wheels 60 are mechanically linked to a steering actuator or gear 66 (see FIG. 2), which is mechanically linked to a steering wheel 64. Alternatively, the front wheels 62 and steering wheel 64 could be part of a steer-by-wire system (not shown). The rear wheels 62 could also be coupled to the steering wheel 64 by the same steering gear 66 or another steering gear (not shown).

In any case, rotation of the steering wheel 64 actuates the steering gear 66 to turn the wheels 60 relative to the centerline 22 in order to steer the vehicle 20. To this end, the steering wheel 64 has a neutral position in which the wheels 60 point in directions that are parallel to the centerline 22 such that the vehicle moves in a straight line. Counterclockwise rotation of the steering wheel 64 angles the wheels 60 leftward relative to the centerline 22 (as shown in FIG. 1), causing the vehicle 20 to turn left. Clockwise rotation of the steering wheel 64 angles the wheels 60 rightward relative to the centerline 22, causing the vehicle 20 to turn right.

The assist system 50 includes camera assemblies 70a-70h provided around the periphery of the vehicle 20. The camera assemblies 70a-70c are secured closer to the front end 24 of the vehicle 20 along or adjacent to the centerline 22. As shown, the camera assembly 70a is secured to the front end bumper. The camera assemblies 70b, 70c are secured to the rear view mirror 46.

Camera assemblies 70d-70e are secured to the left side 27. Camera assemblies 70f-70g are secured to the right side 29. Alternatively, the camera assemblies 70d, 70e and 70f, 70g could be secured to the side view mirrors 33a, 33b, respectively (not shown). A camera assembly 70h is secured to the rear end 26 of the vehicle 20 along or adjacent to the centerline 22. All the camera assemblies 70a-70h face outward away from the vehicle 20. Accordingly, the camera assemblies 70a-70c are front- or forward-facing. The camera assembly 70h is back- or rearward-facing. The camera assemblies 70d-70g are side- or lateral-facing. It will be appreciated that more or fewer camera assemblies can be provided. In any case, all of the camera assemblies 70a-70h are electrically or wirelessly connected to a controller 74 in the vehicle 20.

Each camera assembly 70a-70h has an associated field of view 72a-72h covering a portion of the vehicle exterior 56. Collectively, the fields of view 72a-72h encircle the entire vehicle 20 and can overlap one another. The controller 74 continuously receives images taken by one or more of the camera assemblies 70a-70h within the respective fields of view 72a-72h. The controller 74 includes an image processing module (not shown) that receives and analyzes the data associated with the images from the camera assemblies 70a-70h. The controller 74 can, for example, stitch the images together to form a 360° surround view (not shown) of the vehicle exterior 56. The images can also be relied on to identify objects around the vehicle 20. In some instances, less than all of the cameras 70a-70h are used to detect objects or assist the operator.

Referring to FIG. 2, the controller 74 is also electrically or wirelessly connected to various sensors and actuators in the vehicle 20 for monitoring and controlling several functions of the vehicle, namely, vehicle steering and speed. To this end, the controller 74 is electrically or wirelessly connected to a vehicle speed sensor 76. The speed sensor 76 monitors the vehicle speed and generates an electrical signal 78 indicative thereof that is sent to the controller 74 at predetermined time intervals.

The controller 74 is also electrically or wirelessly connected to an actuator 80 associated with the vehicle brake 82 and a throttle actuator 90 associated with the gas pedal 92. The controller 74 can send a control signal 84 to the brake actuator 80 to decrease the vehicle 20 speed. The controller 74 can send a control signal 94 to the throttle actuator 90 to increase the vehicle 20 speed.

A wheel position sensor 100 monitors the rotational angle of the steering wheel 64 and generates an electrical signal 102 indicative of the steering angle. The signal 102 is sent to the controller 74 at predetermined time intervals. The controller 74 can send a control signal 110 to the steering gear 66 in response to the wheel position signal 102, thereby controlling rotation of the steering wheel 64. The steering gear 66 actuation also controls the steering angle of the front wheels 60 relative to the centerline 22 of the vehicle 20.

At least one proximity sensor 130 can be electrically or wirelessly connected to the controller 74 for acquiring data related to objects around the vehicle exterior 56. The at least one proximity sensor 130 can include, for example, laser scanners, ultrasonic sensors, radar detectors, and LIDAR detectors, for determining and monitoring the distance between the vehicle 20 and objects around the vehicle exterior 56 detected by the camera assemblies 70a-70h. In one example, proximity sensors 130 are provided on the front end 24 and rear end 26 of the vehicle 20. The proximity sensors 130 can, however, be omitted entirely.

Based on this construction, the controller 74 is capable of receiving continuous feedback regarding the driving conditions of the vehicle, e.g., vehicle speed and steering angle, images around the vehicle exterior 56, and the distance between the vehicle and objects identified in the images. The controller 74, in response to these inputs, is capable of controlling or helping to control vehicle operation in a manner that helps increase occupant safety. To this end, the controller 74 can assist with or perform lane keep assistance in response to images sent by the camera assemblies 70a-70h.

An alert 140 is electrically connected to the controller 74 for providing feedback to the operator of the vehicle 20. For example, the alert 140 can provide visual and/or audio feedback to the operator when/while the controller 74 sends a signal 142 thereto. Alternatively or additionally, the controller 74 can actuate a motor 68 connected to the steering wheel 64 for vibrating the same to provide haptic feedback to the operator. In each case, the feedback acts as lane keep assistance for the operator.

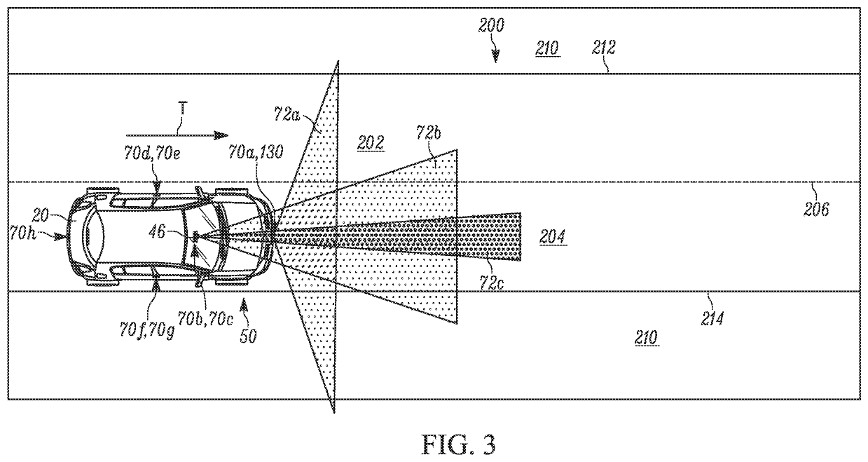

The assist system 50 utilizes different camera assemblies 70a-70h to detect objects around the vehicle exterior 56 on a roadway 200. An example roadway 200 is shown in FIG. 3 and has a direction of vehicle travel illustrated by the arrow T. The roadway 200 includes a series of lanes 202, 204 separated by a dashed dividing line 206. Additional lanes and dividing lines are contemplated but not shown. The roadway 200 is separated from the surrounding off-road terrain 210 by a boundary line 212 on the left side (relative to the traveling direction T) and by a boundary line 214 on the right side.

In one example, as the vehicle 20 travels in the direction T, the camera assemblies 70a-70c capture images of the dividing line 206 and the boundary line 214 that are sent to the controller 74. The controller 74 relies on the images to determine a width w₁ of the lane 204, which corresponds with the distance between the lines 206, 214 in a direction extending perpendicular to the travel direction T. As shown, the width w₁ is between the centerlines of the lines 206, 214.

It will be appreciated that the vehicle 20 can detect the lanes lines 206, 214 and width w₁ thereof without relying on any of the camera assemblies 70a-70h, e.g., sensing sensors in the lane lines 206, 214, GPS data of the roadway, etc.

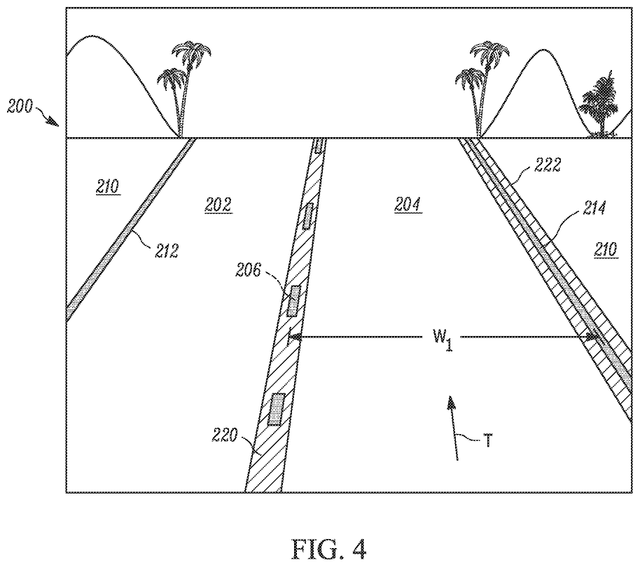

The wheel position sensor 100 continuously supplies signals 102 to the controller 74. As a result, the controller 74 can analyze the images from the cameras 70a-70c and the signals 102 from the proximity sensors 100 and provide autonomous lane keep assistance. Once the controller detects the boundary line 214 and dividing line 206 defining the lane 204, the controller generates a line of engagement 220 and 222, respectively, for each line 206, 214 (see FIG. 4). The controller 74 can actually project or overlay the lines 220, 222 over the lines 206, 214 (as shown) or simply be cognizant of where the lines 220, 222 are spatially relative to the roadway 200 (not shown).

Regardless, the lines of engagement 220, 222 act as markers to help maintain the vehicle within the lane 204. The lines 220, 222 are continuous and consistent in width and are therefore better visual guideposts for the controller 74 than the lines 206, 214, which could each be discrete, inconsistent, vary in intensity, etc. In other words, the lines 206, 214 may not be as reliable as the lines of engagement 220, 222 for lane keep assistance purposes. That said, the controller 74 relies on the proximity sensors 130 to monitor the distance between the vehicle 20 and each line of engagement 220, 222.

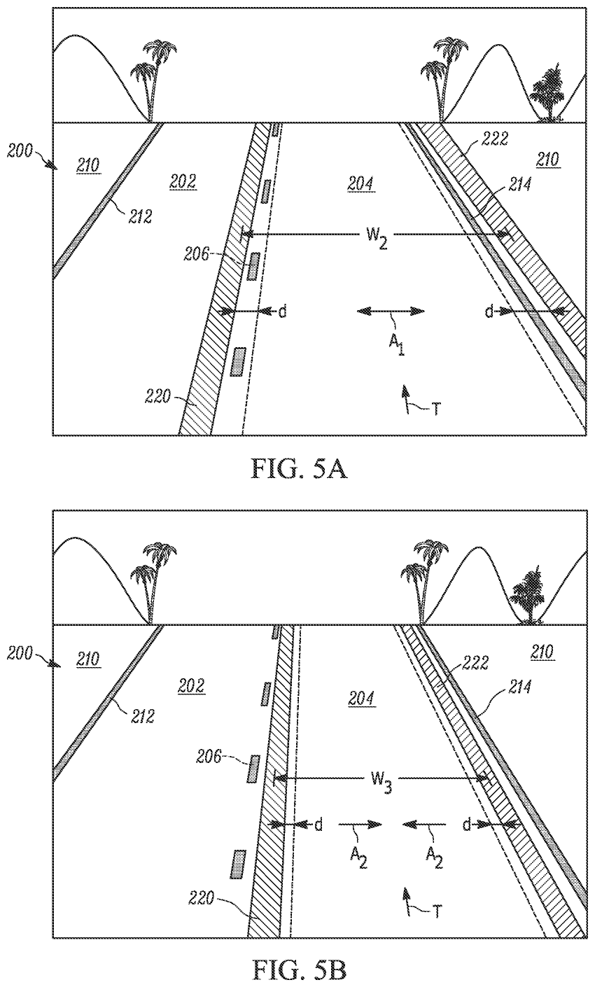

It may be desirable for the controller 74 to adjust the positioning of the lines of engagement 220, 222 relative to the centerlines of the lane lines 206, 214 in response to sensed vehicle conditions and/or roadway conditions, e.g., the driving history of the operator, the position of the vehicle, camera visibility, lane line spacing, lane line visibility and/or environmental conditions on or around the roadway. For instance, and referring to FIGS. 5A-5B, the controller 74 can widen the lines of engagement (FIG. 5A) so as to be spaced apart a distance w₂ greater than the width w₁ of the lane 204. The lines of the engagement 220, 222 are therefore positioned outside the centerlines of the dividing line 206 and boundary line 214, respectively. This can occur when historical data evidences an operator that drives the vehicle 20 within a relatively wider range of the lane 204 and therefore desires less lane keep assistance authority/feedback.

In other words, historical data indicates that the operator does not tend to center the vehicle 20 within the lane 204 and therefore uses a relatively wider range thereof. As a result, the controller 74 can widen the lines of engagement 220, 222 such that the vehicle 20 is provided a wider operating range before lane keep assistance commences. In this manner, the authority or influence of the assist system 50 over the operator is reduced.

Along the same lines, the camera assemblies 70a-70c and/or proximity sensor 130 may indicate that the vehicle 20 is crossing the lane line 206 towards the other lane 202 or crossing the lane line 214 towards the off-road terrain 210. When this occurs, if the controller 74 determines the operator is hands-free, e.g., not engaged with the steering wheel 64, the controller can widen (or eliminate) the lines of engagement 220, 222 to thereby reduce (or eliminate) the assist system 50 authority. This helps reduce or eliminate bouncing of the vehicle 20 between the lane lines 206, 214.

The controller 74 can also widen the lines of engagement 220, 222 when the visibility of the camera assemblies 70a-70c is poor. In other words, when the images acquired by the camera assemblies 70a-70c are blurry, obstructed, etc., due to debris on the camera lens, fog, rain, dust, etc., the controller 74 can widen the lines of engagement 220, 222 to be spaced apart the distance w₃. This can also occur when the width w₁ of the lane 204 changes over time and/or when visibility of either lane line 206, 214 changes over time.

On the other hand, the controller 74 can narrow the lines of engagement (FIG. 5B) so as to be spaced apart a distance w₃ less than the width w₁ of the lane 204. The lines of the engagement 220, 222 are therefore positioned inside the centerlines of the dividing line 206 and boundary line 214. This can occur when historical data evidences an operator that drives the vehicle 20 within a relatively narrow range of the lane 204, e.g., substantially centered therein. As a result, the vehicle 20 is provided a narrower operating range before lane keep assistance commences. In this manner, the authority or influence of the assist system 50 over the operator is increased.

In either situation, the controller 74 relies on the camera assemblies 70a-70c and/or proximity sensor 130 to monitor the distance between the vehicle 20 and the lines of engagement 220, 222 during operation of the vehicle 20. In one example, the controller 74 is configured to notify the operator when the vehicle 20 moves to within a predetermined distance d from either of the lines of the engagement 220, 222. The distance d is the same for both lines of engagement 220, 222 but different predetermined distances could be used for each line (not shown).

Regardless, the controller 74 sends a signal 142 to the alert 140 to provide feedback to the operator that the vehicle 20 is within the predetermined distance d from one of the lines of engagement 220, 222. In addition to the alert 140, the controller 74 can actuate the motor 68 to provide haptic feedback to the operator through the steering wheel 64. The operator can also be presented with visual feedback of the images acquired by the camera assemblies 70a-70c and the lane lines 206, 214 and/or lines of engagement 220, 222 on a display in the vehicle interior 54 (not shown).

The controller 74 can be configured to increase the severity of the feedback to the operator as the vehicle 20 moves closer and closer to the line of engagement 220, 222. To this end, the severity of the haptic feedback can increase and/or any audio or visual feedback can increase in volume and/or intensity. Conversely, the severity of the feedback can be reduced as the operator moves the vehicle 20 away from the line of the engagement 220 or 222.

In another example, the severity of the feedback can vary depending on which line of engagement 220, 222 the vehicle 20 is moving towards. More specifically, the controller 74 can be configured to provide more severe feedback to the operator when the vehicle 20 moves towards the lane line 206/line of engagement 220 (closer to oncoming traffic) compared to when the vehicle moves towards the lane line 214/line of engagement 222 (closer to the off-road terrain 210). Feedback to the operator can also start sooner when the vehicle 20 moves towards the line of engagement 220 compared to when the vehicle moves towards the line of engagement 222. With this in mind, the lines of engagement 220, 222 themselves can vary (in spacing from respective lane line 206, 214, width, etc.) depending on their relative position to the vehicle 20, i.e., left or right thereof, to meet this objective.

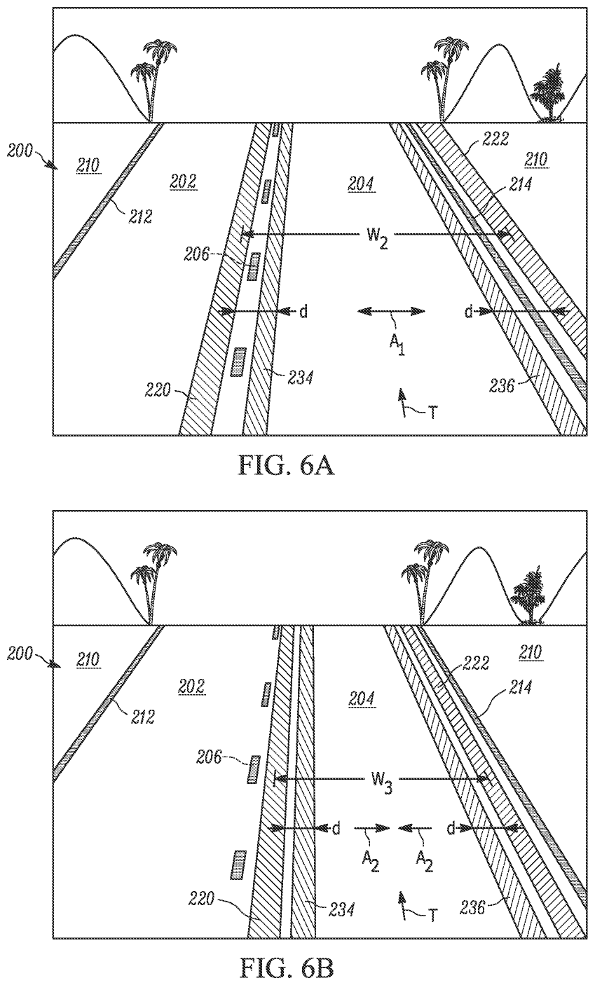

In other example shown in FIG. 6A, the controller 74 can overlay or project multiple pairs of engagement lines onto the roadway 200 that are adjusted based on the aforementioned conditions. Referring to FIG. 6A, outer engagement lines 230, 232 are positioned outside the centerlines of the lane lines 206, 214 and are spaced the distance w₂ apart from one another, i.e., the outer lines of engagement are moved outward in the manner A₁ relative to the lane lines. Inner lines of engagement 234, 236 extend parallel to the respective outer lines of engagement 230, 232 and are spaced inward from the centerlines thereof by the predetermined distance d.

As a result, the controller 74 begins providing feedback, e.g., audio, visual, and/or haptic, to the operator when the vehicle 20 moves over either inner line of engagement 234, 236. The feedback increases as the vehicle 20 moves closer to the outer lines of the engagement 230, 232. The severity of the feedback can be reduced as the operator moves the vehicle 20 away from the line of the engagement 230 or 232.

Referring to FIG. 6B, the outer engagement lines 230, 232 are positioned inside the centerlines of the lane lines 206, 214 and are spaced the distance w₃ apart from one another, i.e., the outer lines of engagement are moved inward in the manner A₂ relative to the lane lines. The inner lines of engagement 234, 236 extend parallel to the respective outer lines of engagement 230, 232 and are spaced inward therefrom by the predetermined distance d. As a result, the controller 74 begins providing feedback to the operator when the vehicle 20 moves over either inner line of engagement 234, 236. The feedback increases as the vehicle 20 moves closer to the outer line of the engagement 230, 232. The severity of the feedback can be reduced as the operator moves the vehicle 20 away from the line of the engagement 230 and 232.

It will be appreciated that the assist system 50 of the present invention can also be used when only one of the lane lines 206, 214 is detected or present. This can occur when, for example, the roadway 200 is in a rural area and only the dividing line 206 is present. Alternatively, the camera assemblies 70a-70c may only be capable of detecting one of the lane lines 206, 214. In these cases, the controller 74 presumes the lane width is standard, e.g., a width of w₁, and artificially generates the missing lane line 206 or 214. The controller 74 can then create and modify the lines of the engagement 220, 222 or 230, 232, 234, 236 based on the detected and artificially generated lane lines 206, 214. Feedback is provided to the operator in the same manner as described above.

As noted, the assist system 50 shown and described provides passive assistance to the operator of the vehicle 20. More specifically, the feedback gives the operator the opportunity to correct the position of the vehicle 20. It will be appreciated, however, that the assist system 50 can also provide active assistance, e.g., automatically correct the position of the vehicle 20 without operator intervention.

To this end, the proximity sensor 130 detects that the vehicle 20 is within a predetermined distance from the line of engagement 220 [or crosses the line of engagement 234], the controller 74 actuates the steering gear 66 to rotate the steering wheel 64 clockwise from the neutral position. This pivots the wheels 60 and causes the vehicle 20 to move laterally towards the boundary line 214. Once the proximity sensor 130 indicates that the vehicle 20 is spaced a desired distance from both lines of engagement 220, 222 the controller 74 returns the steering wheel 64 to the neutral position such that the vehicle 20 travels in a straight line in the lane 204 in the direction T.

Similarly, if the proximity sensor 130 detects that the vehicle 20 is within a predetermined distance from the line of engagement 222 [or crosses the line of engagement 236], the controller 74 actuates the steering gear 66 to rotate the steering wheel 64 counterclockwise from the neutral position. This pivots the wheels 60 and causes the vehicle 20 to move laterally towards the dividing line 206. Once the proximity sensor 130 indicates that the vehicle 20 is spaced a desired distance from both lines of engagement 230, 232 the controller 74 returns the steering wheel 64 to the neutral position such that the vehicle 20 travels in a straight line in the lane 204 in the direction T. In both instances, the controller 74 sends a signal 142 to the alert 140 and/or actuates the motor 68 to provide feedback to the operator before and/or while the autonomous steering correction is made to maintain the vehicle 20 between the lines 206, 214.

The assist system of the present invention is advantageous in that it can dynamically change the lines of engagement used for lane keep assistance in response to sensed operator, vehicle, environmental, etc. conditions. In this manner, the assist system can better adapt to real-time conditions and provide a more tailored/adaptive lane keep assistance to the operator.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method for assisting operation of a vehicle traveling on a roadway, comprising:
detecting at least one lane line on the roadway;
generating a line of engagement for each lane line;
positioning the line of engagement spaced from a centerline of each respective lane line;
monitoring a distance between the vehicle and the positioned lines of engagement; and
automatically performing lane keep assistance in response to the vehicle position relative to the lines of engagement.

2. The method of claim 1, wherein the lines of engagement are positioned in response to at least one sensed vehicle condition, operator history, driver condition or roadway condition.

3. The method of claim 2, wherein the roadway condition comprises roadway visibility and lines of engagement are positioned outside the lane lines in response to roadway visibility being below a predetermined value.

4. The method of claim 2, wherein the roadway condition comprises lane line spacing and the lines of engagement are positioned outside the lane lines in response to a spacing between the lane lines changing more than a predetermined amount over time.

5. The method of claim 2, wherein the roadway condition comprises lane line spacing and the lines of engagement are positioned inside the lane lines in response to a spacing between the lane lines changing more than a predetermined amount over time.

6. The method of claim 2, wherein the vehicle condition comprises operator driving history and the lines of engagement are positioned outside the lane lines in response to monitoring a position of the vehicle within the lane over time.

7. The method of claim 2, wherein the vehicle condition comprises operator driving history and the lines of engagement are positioned inside the lane lines in response to monitoring a position of the vehicle within the lane over time.

8. The method of claim 1, wherein automatically performing lane keep assistance comprises alerting an operator of the vehicle when the vehicle moves to within the predetermined distance from one of the lines of engagement.

9. The method of claim 8, wherein alerting the operator includes providing haptic feedback to the operator through a steering wheel of the vehicle.

10. The method of claim 9, wherein the haptic feedback increases in intensity as the vehicle moves toward one of the lines of engagement.

11. The method of claim 8, wherein the severity of the alert associated with each line of engagement is different from one another.

12. The method of claim 1, wherein the line of engagement on a left side of the vehicle is different from the line of engagement on a right side of the vehicle.

13. The method of claim 1, further comprising positioning second lines of engagement between the lines of engagement and spacing the second lines of engagement from the lines of engagement by the predetermined distance.

14. The method of claim 13, wherein automatically performing lane keep assistance includes providing haptic feedback to an operator of the vehicle through a steering wheel of the vehicle when the vehicle crosses one of the second lines of engagement.

15. The method of claim 14, wherein the haptic feedback increases in intensity as the vehicle moves closer to one of the lines of the engagement.

16. A method for assisting operation of a vehicle traveling on a roadway, comprising:
detecting lane lines on the roadway;
generating inner and outer lines of engagement for each lane line spaced a predetermined distance from one another;
positioning the inner and outer lines of engagement spaced from a centerline of each respective lane line; and
automatically performing lane keep assistance in response to the vehicle crossing either of the inner lines of engagement.

17. The method of claim 16, wherein the lines of engagement are positioned in response to at least one sensed vehicle condition or roadway condition.

18. The method of claim 16, wherein the roadway condition comprises roadway visibility and the outer lines of engagement are positioned outside the lane lines in response to visibility within the field of view being below a predetermined value.

19. The method of claim 16, wherein the roadway condition comprises roadway spacing and the outer lines of engagement are positioned outside the lane lines in response to a spacing between the lane lines changing more than a predetermined amount over time.

20. The method of claim 16, wherein the vehicle condition comprises operator driving history and the outer lines of engagement are positioned outside the lane lines in response to monitoring a position of the vehicle within the lane over time.

21. The method of claim 16, wherein the vehicle condition comprises operator driving history and the outer lines of engagement are positioned inside the lane lines in response to monitoring a position of the vehicle within the lane over time.

22. The method of claim 16, wherein automatically performing lane keep assistance comprises alerting an operator of the vehicle when the vehicle crosses either of the inner lines of engagement.

23. The method of claim 22, wherein alerting the operator comprising includes haptic feedback to the operator through a steering wheel of the vehicle that increases in intensity as the vehicle moves towards one of the outer lines of engagement.
